(19) United States
(12) Patent Application Publication
(10) Pub. No.: US 2017/0364499 A1
(43) Pub. Date: Dec. 21, 2017

(54) CONCEALMENT OF CONTENT IN A SHARED DOCUMENT

(71) Applicant: International Business Machines Corporation, Armonk, NY (US)

(72) Inventors: Wen Min Dou, Beijing (CN); Qi Feng Huo, Beijing (CN); Yu Ji, Beijing (CN); Kam Sing Kuan, Hong Kong (HK); Hua Shao, Beijing (CN); Jin Jing Xie, Beijing (CN); Yu Wang, Beijing (CN); Lin Yuan, Beijing (CN); Hai Feng Zhang, Beijing (CN)

(21) Appl. No.: 15/186,569

(22) Filed: Jun. 20, 2016

(51) Int. Cl. G06F 17/24; G06F 3/0484; G06F 3/0482; H04N 1/44; G06F 17/30

(52) U.S. Cl. CPC G06F 17/24; H04N 1/4493; G06F 17/30011; G06F 3/0482; G06F 3/04847; G06F 17/246

(57) ABSTRACT

A first set of concealment attributes is received from a first user. The first set of user concealment attributes are associated with a document. A first set of document concealment attributes is received from the user. The first set of document concealment attributes are associated with the document. The document, based on the first set of concealment attributes and the first set of document concealment attributes, is stored.

### BACKGROUND

The present invention relates generally to the field of shared documents, and more particularly to concealing content in a shared document.

Today, many employees of a company occupy the same office building. The close proximity provided by the building simplifies collaboration between the employees. Some circumstances may dictate that an employee, or multiple employees, telecommute (i.e., work from a remote location such as home or a hotel if travelling for business). In addition, because the Internet is capable of connecting employees from essentially anywhere in the world, an employee can complete assignments while in a different city, state, or country. Working collaboratively to create or update a document, such as a spreadsheet or text file, can be accomplished with relative ease.

### SUMMARY OF THE INVENTION

Embodiments of the present invention include a method, computer program product, and system for concealing content in a shared document. In one embodiment, a first set of concealment attributes is received from a first user. The first set of user concealment attributes are associated with a document. A first set of document concealment attributes is received from the user. The first set of document concealment attributes are associated with the document. The document, based on the first set of concealment attributes and the first set of document concealment attributes, is stored.

### BRIEF DESCRIPTION OF THE DRAWINGS

FIG. 1 depicts a functional block diagram of a computing environment, in accordance with an embodiment of the present invention;

FIG. 2 depicts a flowchart of a program for concealing content in a shared document, in accordance with an embodiment of the present invention;

FIG. 3A, FIG. 3B, FIG. 3C, FIG. 3D, FIG. 3E, FIG. 3F, FIG. 3G, FIG. 3H, FIG. 3I, and FIG. 3J depict examples of concealing content in a shared document, in accordance with an embodiment of the present invention; and

FIG. 4 depicts a block diagram of components of the computing environment of FIG. 1, in accordance with an embodiment of the present invention.

### DETAILED DESCRIPTION

Embodiments of the present invention provide for concealing content in a shared document. A document may be text document, a spreadsheet, a workbook (i.e., a group of spreadsheets), a presentation, a database file, a project management file, and the like. Consider a team of employees working collaboratively on a document to share with a customer. A team leader may create, in this case, a spreadsheet, may assign tasks to specific team members, and may store the document to a server accessible by all team members. A problem arises if a particular member of the team is not authorized to view certain content included in the document (e.g., an employee in Engineering should not view the salary information column in a spreadsheet provided by a representative from Human Resources (HR)). An inconvenient solution is for the team to partially complete the spreadsheet and then provide the spreadsheet to HR so that the salary column can be added. Problems created by this solution include potential delays in completing the spreadsheet since work is done sequentially rather than simultaneously and some members of the team may need the salary information to complete their portion of the work so even more time is added to complete the project.

Embodiments of the present invention recognize that there may be a method, computer program product, and computer system for concealing content in a shared document. The method, computer program product, and computer system may allow the document owner, or delegate of the owner, to conceal specific content by either masking the content (i.e., redacting the content) or making the content invisible (i.e., hiding the content such that the content does not appear to exist within the document).

The present invention will now be described in detail with reference to the Figures.

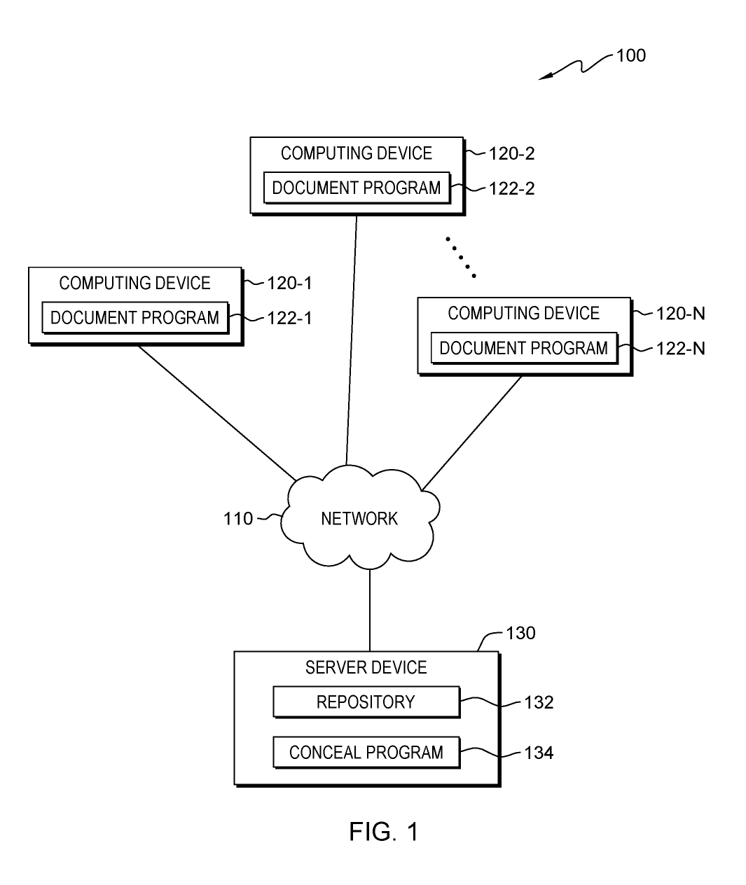

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes computing device 120-1, computing device 120-2, computing device 120-N (i.e., any number of computing device 120), and server device 130 connected to network 110. Computing device 120-N will be used throughout to represent all computing devices in computing environment 100. In example embodiments, computing environment 100 may include other computing devices (not shown) such as smartwatches, cell phones, smartphones, wearable technology, phablets, tablet computers, laptop computers, desktop computers, other computer servers or any other computer system known in the art, interconnected with computing device 120-N and server device 130 over network 110.

In example embodiments, computing device 120-N and server device 130 may connect to network 110, which enables computing device 120-N and server device 130 to access other computing devices and/or data not directly stored on computing device 120-N and server device 130, respectively. Network 110 may be, for example, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between computing device 120, server device 130, and any other computing device connected to network 110, in accordance with embodiments of the present invention. In an embodiment, data received by another computing device in computing environment 100 (not shown) may be communicated to computing device 120-N and server device 130 via network 110.

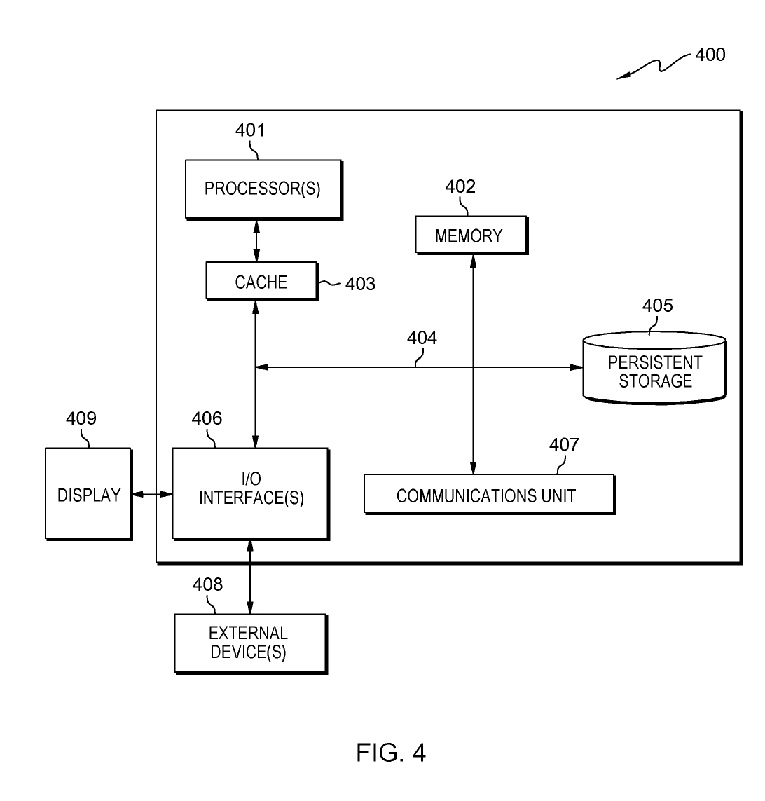

In embodiments of the present invention, computing device 120-N may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, computing device 120-N represents a computer system utilizing clustered computers and components (e.g., database server computers, application server computers, etc.) that act as a single pool of seamless resources when accessed by elements of computing environment 100. In general, computing device 120-N is representative of any electronic device or combination of electronic devices capable of executing computer readable program instructions. As previously mentioned, computing environment 100 may include any number of computing device 120-N. Computing device 120-N may include components as depicted and described in further detail with respect to FIG. 4, in accordance with embodiments of the present invention.

In an embodiment, computing device 120-N includes document program 122-N. According to embodiments of the present invention, document program 122-N is a program used to create a document. In an embodiment, the document type may be a text file, a spreadsheet file, a set of spreadsheet files (i.e., a spreadsheet workbook), a presentation file, a database file, a project management file, and the like. Document program 122-N may be a program, a subprogram (e.g., a command) of a larger program, an application, a plurality of applications, or mobile application software, which functions to create documents. A program is a sequence of instructions written by a programmer to perform a specific task. Document program 122-N may run by itself but may be dependent on system software (not shown) to execute. In one embodiment, document program 122-N functions as a stand-alone program residing on computing device 120-N. In another embodiment, document program 122-N may be included as a part of server device 130. In yet another embodiment, document program 122-N may work in conjunction with other programs, applications, etc., found on computing device 120-N, server device 130, or in computing environment 100. In yet another embodiment, document program 122-N may be found on other computing devices (not shown) in computing environment 100 which are interconnected to computing device 120-N and server device 130 via network 110. In an embodiment, document program 122-N includes a ‘conceal’ icon (not shown), which activates and deactivates a concealment function used to select content in a document that a user intends to conceal.

In embodiments of the present invention, server device 130 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, server device 130 represents a computer system utilizing clustered computers and components (e.g., database server computers, application server computers, etc.) that act as a single pool of seamless resources when accessed by elements of computing environment 100. In general, server device 130 is representative of any electronic device or combination of electronic devices capable of executing computer readable program instructions. Server device 130 may include components as depicted and described in further detail with respect to FIG. 4, in accordance with embodiments of the present invention.

In an embodiment, server device 130 includes repository 132 and conceal program 134. According to an embodiment of the present invention, repository 132 may be storage that may be written to and/or read by computing device 120-N. In one embodiment, repository 132 resides on server device 130. In other embodiments, repository 132 may reside on computing device 120-N, on any other device (not shown) in computing environment 100, in cloud storage, or on another computing device accessible via network 110. In yet another embodiment, repository 132 may represent multiple storage devices within server device 130. In an embodiment, repository 132 may be managed by conceal program 134. In an alternative embodiment, repository 132 may be managed by the operating system of server device 130, alone, or together with, conceal program 134. Repository 132 may be implemented using any volatile or non-volatile storage media for storing information, as known in the art. For example, repository 132 may be implemented with a tape library, optical library, one or more independent hard disk drives, multiple hard disk drives in a redundant array of independent disks (RAID), solid-state drives (SSD), or random-access memory (RAM). Similarly, repository 132 may be implemented with any suitable storage architecture known in the art, such as a relational database, an object-oriented database, or one or more tables. In an embodiment of the present invention, document program 122-N, conceal program 134, and any other programs and applications (not shown) operating on computing device 120-N may store, read, modify, or write data to repository 132.

According to embodiments of the present invention, conceal program 134 may be a program, a subprogram (e.g., a command) of a larger program, an application, a plurality of applications, or mobile application software, which functions to conceal content in a shared document. A program is a sequence of instructions written by a programmer to perform a specific task. Conceal program 134 may run by itself but may be dependent on system software (not shown) to execute. In one embodiment, conceal program 134 functions as a stand-alone program residing on server device 130. In another embodiment, conceal program 134 may be included as a part of computing device 120. In yet another embodiment, conceal program 134 may work in conjunction with other programs, applications, etc., found on computing device 120, server device 130, or in computing environment 100. In yet another embodiment, conceal program 134 may be found on other computing devices (not shown) in computing environment 100 which are interconnected to computing device 120-N and server device 130 via network 110.

According to embodiments of the present invention, conceal program 134 functions to conceal content in a shared document stored to a repository. According to an embodiment of the present invention, conceal program 134 allows a user to mask content in a document or make content in a document invisible to one or more viewers of the document. In an embodiment, a user of computing device 120-N accesses a shared document, via document program 122-N, stored to repository 132, and conceal program 134 applies any applicable user concealment attributes and document concealment attributes.

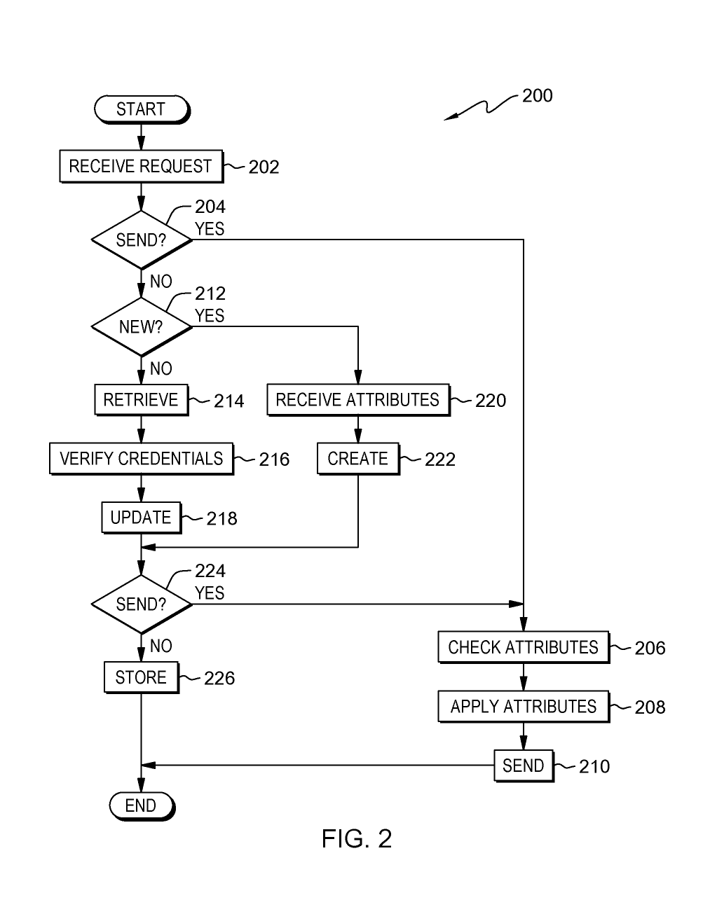

FIG. 2 is a flowchart of workflow 200 depicting a method for concealing content in a shared document, in accordance with an embodiment of the present invention. In one embodiment, the method of workflow 200 is performed by conceal program 134. In an alternative embodiment, the method of workflow 200 may be performed by any other program working with conceal program 134. In an embodiment, a user, via document program 122-N, may invoke workflow 200 upon the user creating a new document. In an alternative embodiment, a user, via document program 122-N, may invoke workflow 200 upon accessing conceal program 134.

In an embodiment, conceal program 134 receives a request (step 202). In other words, conceal program 134 receives a request from a user to (i) send an existing document to the user, (ii) to update an existing document for the user, or (iii) to create a new document for the user. In an embodiment, the document type may be a text file, a spreadsheet file, a set of spreadsheet files (i.e., a spreadsheet workbook), a presentation file, a database file, a project management file, and the like. In an embodiment, a user of computing device 120-2 creates a new spreadsheet using document program 122-2, and the user sends the information concerning the spreadsheet to server device 130 via network 110.

In an embodiment, conceal program 134 determines whether the request is to send an existing document (decision step 204). In other words, conceal program 134 determines whether a user requests that an existing document be sent to the user. In an embodiment (decision step 204, YES branch), the request is to send an existing document to the user; therefore, conceal program 134 proceeds to step 206. In the embodiment (decision step 204, NO branch), the request is not to send an existing document to the user; therefore, conceal program 134 proceeds to decision step 212.

In an embodiment, conceal program 134 checks attributes (step 206). In other words, responsive to determining that the request is to send an existing document to a user, conceal program 134 checks (i.e., reviews) the user concealment attributes as well as the document concealment attributes for the document requested by the user against the concealment attributes of the user. In an embodiment, the existing document is stored to repository 132 on server device 130. In an embodiment, user concealment attributes may include whether the user is the owner of the requested document (i.e., has the authority to edit the entire document), whether the user is a delegate of the owner of the requested document (i.e., has the authority from the owner to edit portions of or the entire document), or whether the user has the authority to view portions of or the entire document. In an embodiment, document concealment attributes may include the various concealment types included in the document (e.g., masked content, invisible content, both masked and invisible content), and the scope of any included concealment in the document (e.g., a range of cells in a spreadsheet; a column, a row, multiple columns, multiple rows, or a combination of columns and rows in a spreadsheet; a sheet in a spreadsheet workbook; a line or lines in a text document; a paragraph in a text document; a page in a text document; etc.). In an embodiment, document concealment attributes in a document may be indicated by the user highlighting a range of cells in a spreadsheet, by the user selecting a one or more rows and/or one or more columns in spreadsheet, by the user selecting text in a text file, or by any other selection technique known in the art. In an embodiment, the user concealment attributes and the document concealment attributes may be stored to repository 132. In an embodiment, conceal program 134 determines that the requested spreadsheet includes masked cells and an invisible row for the user requesting the document.

In an embodiment, conceal program 134 applies attributes (step 208). In other words, responsive to reviewing the user concealment attributes and the document concealment attributes for the requested document, conceal program 134 applies the user concealment attributes and the document concealment attributes to the requested document. In an embodiment, conceal program 134 determines that the user requesting the document is the owner of the document and therefore, there are no document concealment attributes to apply to the document relative to the owner but that there may be document concealment attributes to apply to the document relative to one or more other users. In another embodiment, conceal program 134 determines that the user requesting the document is not authorized to see certain portions of the document and therefore, conceal program 134 applies the user concealment attributes to the requested document. In an embodiment, conceal program 134 masks the cells indicated for concealment in the spreadsheet and makes the row indicated for concealment invisible in the spreadsheet per the document concealment attributes (step 206).

In an embodiment, conceal program 134 sends the document (step 210). In other words, conceal program 134 fully renders the document, with the included applied user concealment attributes and document concealment attributes, and sends the document to the user requesting the document. In an embodiment, conceal program 134 sends the requested document from server device 130 to the user of computing device 120-2, via network 110, for viewing in document program 122-2.

In an embodiment, conceal program 134 determines whether the request received in step 202 is to create a new document for the user (decision step 212). In other words, responsive to determining that the request was not to send an existing document to a user in decision step 204, conceal program 134 determines whether the request is to create a new document for a user. In an embodiment (decision step 212, YES branch), the request is to create a new document; therefore, conceal program 134 proceeds to step 220. In the embodiment (decision step 212, NO branch), the request is not to create a new document; therefore, conceal program 134 proceeds to step 214.

In an embodiment, conceal program 134 retrieves the document (step 214). In other words, responsive to determining that the received request is not to create a new document (decision step 212, NO branch), conceal program 134 retrieves an existing document from a repository so that updates, provided by a user, may be applied to the existing document. In an embodiment, the retrieved document may include no user or document concealment attributes. In another embodiment, the retrieved document may include one or more document concealment attributes such as masked cells in a spreadsheet, invisible rows and/or columns in a spreadsheet, an invisible sheet in a group of spreadsheets, and the like. In an embodiment, conceal program 134 retrieves a spreadsheet stored to repository 132 on server device 130, which includes two invisible columns (column B and column C).

In an embodiment, conceal program 134 verifies credentials (step 216). In other words, conceal program 134 verifies that the credentials of the user requesting an update to an existing document match the user concealment attributes associated with the existing document. In an embodiment, conceal program 134 verifies that the user requesting to update the existing document is the owner of the document. In another embodiment, conceal program 134 verifies that the user requesting an update to the existing document has been granted authority to update the existing document (e.g., is a delegate of the owner of the document and has the authorization to update the document). In yet another embodiment, if the existing document includes one or more user concealment attributes, conceal program 134 verifies that the user requesting to update the existing document is the owner of the document or is a delegate of the owner of the document with authority to update the one or more areas of the existing document with user concealment attributes. In an embodiment, the owner of the existing document may update any portion of the existing document. In another embodiment, the owner of the existing document may delegate to one or more other users the authority to update one or more portions of the existing document. In yet another embodiment, the owner of the existing document may delegate to one or more other users the authority to update only portions of the existing document without user concealment attributes (i.e., content viewable to the delegated user). In yet another embodiment, the owner of the existing document may delegate to one or more other users the authority to update the areas of the existing document without document concealment attributes (i.e., content viewable to all users) and one or more areas of the existing document with document concealment attributes (i.e., content viewable to the delegated user). In an embodiment, a user of computing device 120-2, using document program 122-2, requests an update to a document stored to repository 132 on server device 130 and conceal program 134 verifies that the user is a delegate of the owner of the document with the authority to update all portions of the document, including any portions with document concealment attributes.

In an embodiment, conceal program 134 updates the document (step 218). In other words, responsive to verifying the credentials of the user requesting an update, from the user, to an existing document, conceal program 134 updates the existing document with the requested update (e.g., changing the data in a row of the existing document) while complying with any user concealment attributes and document concealment attributes associated with the existing document. The result is an updated version of the existing document. In an embodiment, conceal program 134 updates the data in a row of an existing spreadsheet, stored to repository 132 on server device 130, with a concealment attribute of invisible.

In an embodiment, conceal program 134 receives attributes (step 220). In other words, responsive to determining that a user has requested to create a new document (decision step 212, YES branch), conceal program 134 receives the user and document concealment attributes for the new document from the user. In an embodiment, user concealment attributes and document concealment attributes for the new document include a list of users that may view or edit the new document, concealment requirements for the users that may view or edit the new document, the various concealment types included in the new document (e.g., masked content, invisible content, both masked and invisible content), and the scope of any included concealment in the new document (e.g., a range of cells in a spreadsheet; a column, a row, multiple columns, multiple rows, or a combination of columns and rows in a spreadsheet; a sheet in a spreadsheet workbook; a line or lines in a text document; a paragraph in a text document; a page in a text document; etc.). In an embodiment, a user of computing device 120-2 sends user and document concealment attributes for a new document to server device 130 and conceal program 134 stores the received user concealment attributes and document concealment attributes to repository 132.

In an embodiment, conceal program 134 creates the document (step 222). In other words, conceal program 134 creates the new document based on the user concealment attributes and document concealment attributes received in step 220. In an embodiment, the new document may include no user or document concealment attributes. In another embodiment, the new document may include one or more user or document concealment attributes. In an embodiment, conceal program 134 creates a new spreadsheet based on user and document concealment attributes stored to repository 132 on server device 130.

In an embodiment, conceal program 134 determines whether to send the document (decision step 224). In other words, responsive to updating an existing document (step 218) or creating a new document (step 222), conceal program 134 determines whether to send the updated document or the new document to the user requesting the update or the user requesting the new document, respectively. The determination to send the updated document of the new document is based on whether a send request is included in the request to update an existing document or the request to create a new document. In an embodiment (decision step 224, YES branch), the updated document or the new document is sent to the respective user; therefore, conceal program 134 proceeds to step 206 to check the user concealment attributes and document concealment attributes of the updated document or the new document. In the embodiment (decision step 224, NO branch), the updated document or the new document is not sent to the respective user; therefore, conceal program 134 proceeds to step 226 to store the updated or new document.

In an embodiment, conceal program 134 stores the document (step 226). In other words, responsive to determining that an updated document or a new document is not to be sent, conceal program 134 stores the updated document or the new document. In an embodiment, the updated document or the new document is stored to local memory such as repository 132 or other memory (not shown) on server device 130. In another embodiment, the updated document or the new document is stored to memory accessible via network 110 such as memory found on computing device 120-N or cloud based memory. In an embodiment, conceal program 134 stores an updated document to repository 132 on server device 130.

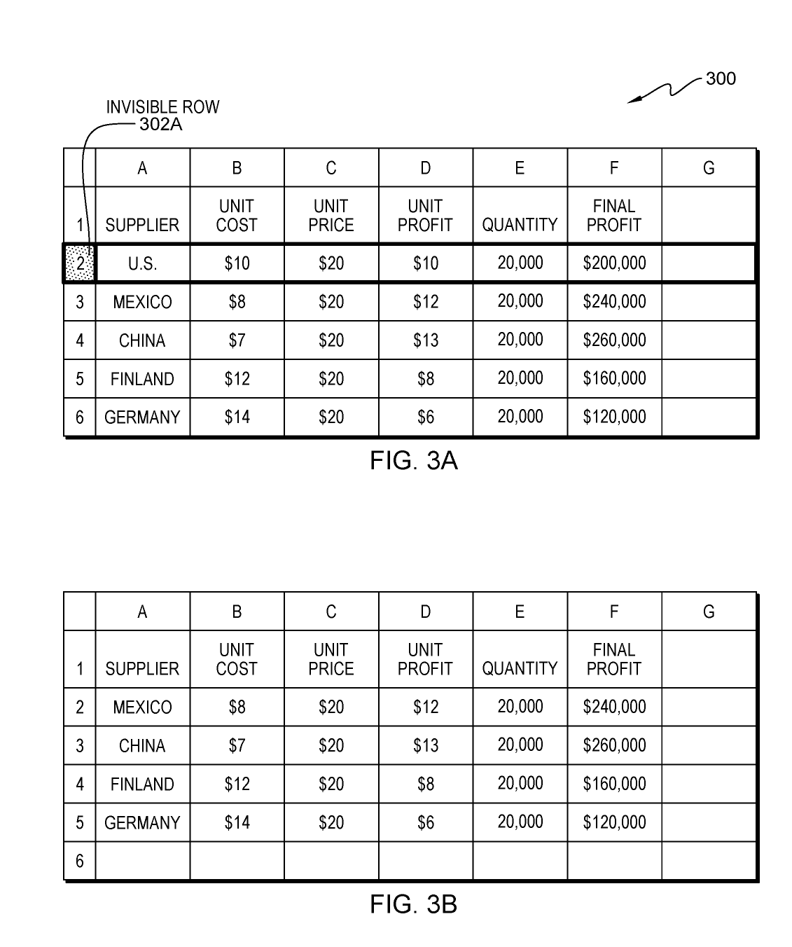

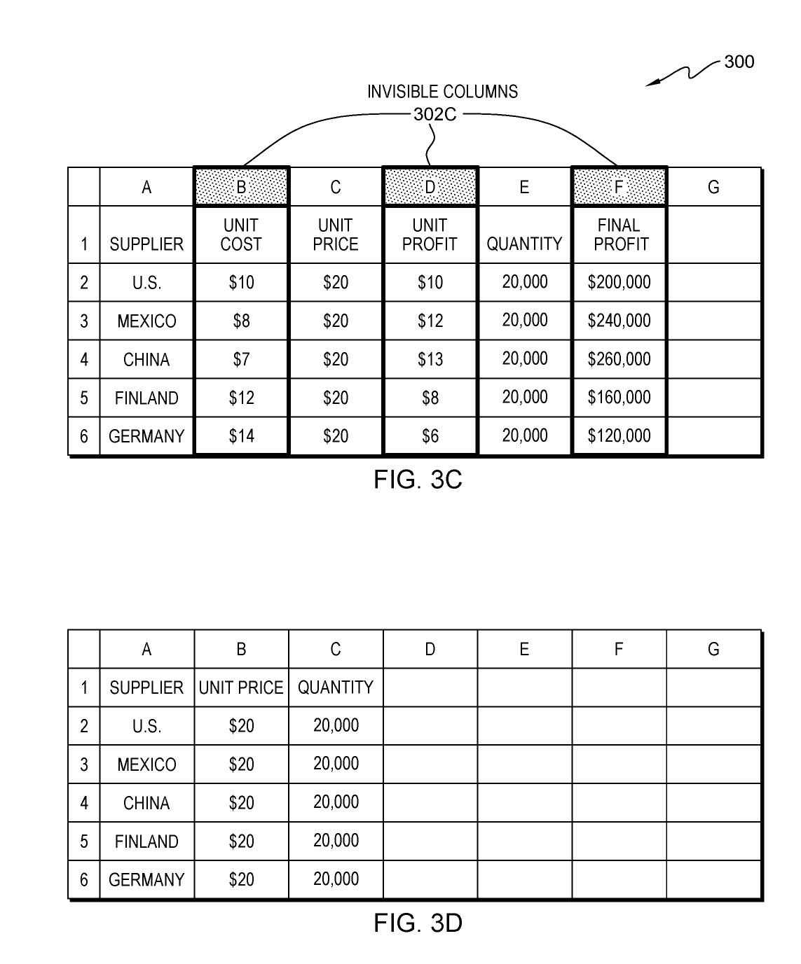

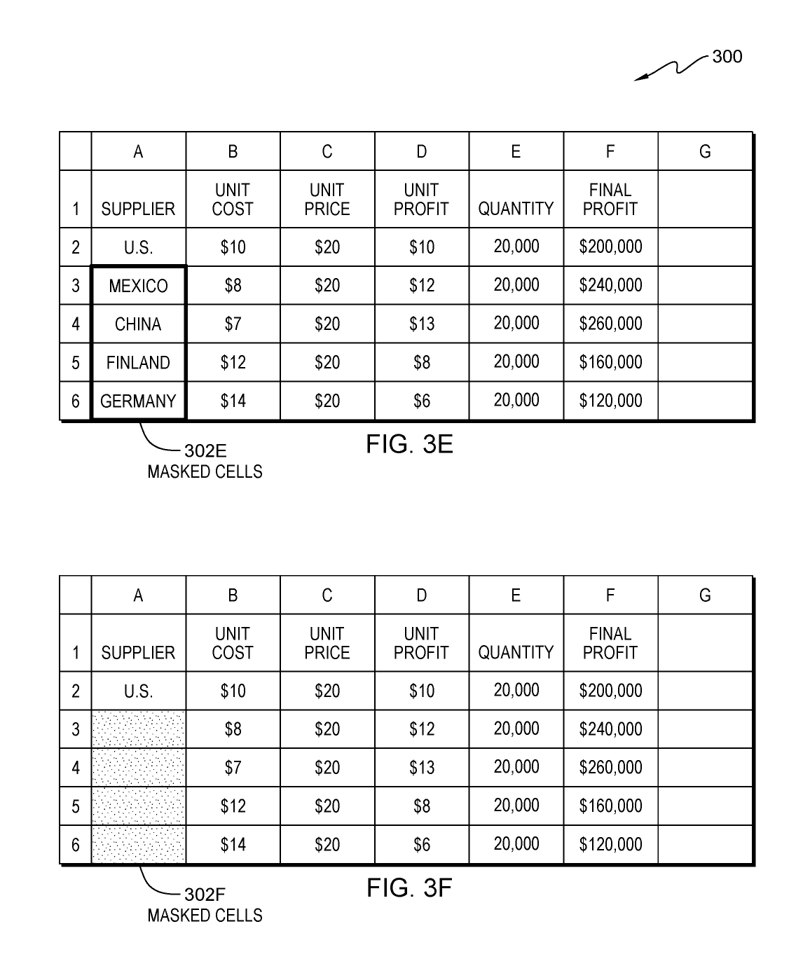

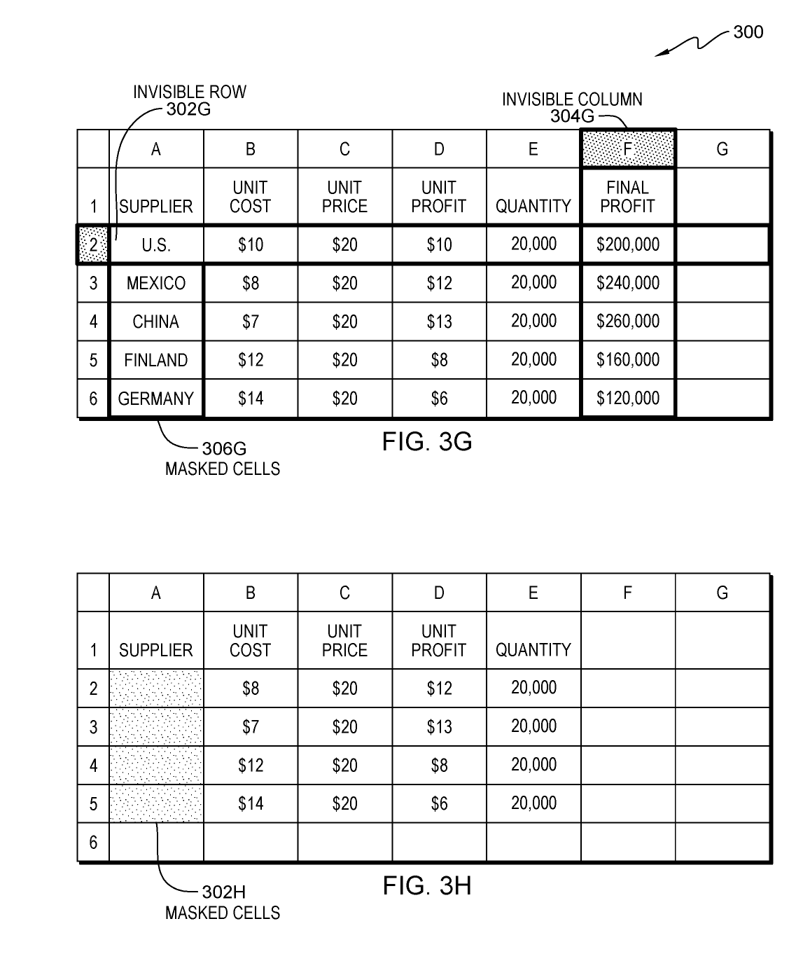

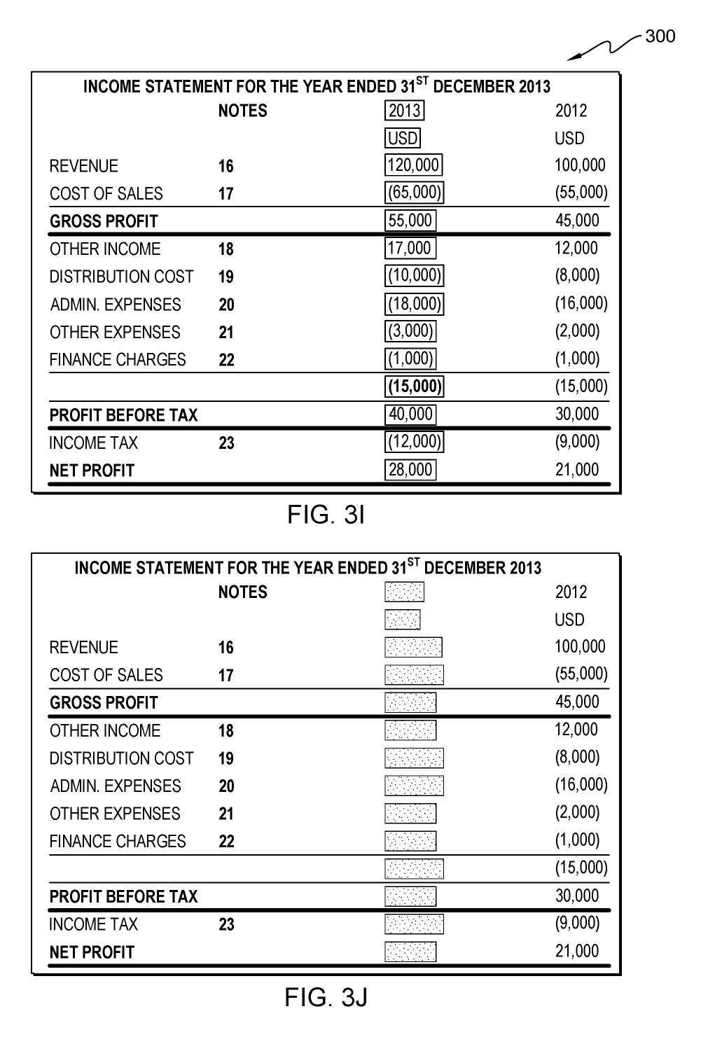

The present invention will now be described using the concealing content 300 examples shown in FIG. 3A, FIG. 3B, FIG. 3C, FIG. 3D, FIG. 3E, FIG. 3F, FIG. 3G, FIG. 3H, FIG. 3I, and FIG. 3J. In a first example of creating a new document depicted in FIG. 3A, John intends to make “Row 2” in a new spreadsheet containing six rows of data invisible to Jane. John first activates the concealment function by clicking a ‘conceal’ icon (not shown). John then selects invisible row 302A by right clicking a mouse on the “Row 2” identifier in the spreadsheet. John completes the concealment activity by clicking the ‘conceal’ icon (not shown) another time to select the content for concealment. As shown in FIG. 3A, the cell with the “Row 2” identifier is shaded and the entire row is outlined. When Jane requests to see the spreadsheet, the result of the concealment is shown in FIG. 3B. After concealment, there are only five rows of data visible to Jane and the row containing the U.S. data is no longer visible to Jane. “Row 2” in FIG. 3A has not been deleted from the spreadsheet shown in FIG. 3B. “Row 2” is hidden from Jane and Jane would not know that “row 2” was a part of the spreadsheet (i.e., there is not a blank row after concealment except where there were blank rows in the spreadsheet prior to concealment).

In a second example of updating an existing document depicted in FIG. 3C, John intends to make columns B, D, and F in an existing spreadsheet invisible to Jane. John first activates the concealment function by clicking a ‘conceal’ icon (not shown). John then selects each invisible column 302C by right clicking a mouse the “column B”, “column D”, and “column F” identifiers in the spreadsheet. John completes the concealment activity by clicking the ‘conceal’ icon (not shown) another time to select the content for concealment. As shown in FIG. 3C, the cell with the “column B” identifier is shaded and the entire column is outlined. The same features also apply to “column D” and “column F”. When Jane requests to see the spreadsheet, the result of the concealment is shown in FIG. 3D. After concealment, there are only three columns of data visible to Jane and the columns containing the Unit Cost, Unit Profit, and Final Profit are no longer visible to Jane. “Column B”, Column D″, and “Column F” have not been deleted from the spreadsheet shown in FIG. 3D. “Column B”, Column D″, and “Column F” are hidden from Jane and Jane would not know that “Column B”, Column D″, and “Column F” were a part of the spreadsheet (i.e., there are not blank columns after concealment except where there were blank columns in the spreadsheet prior to concealment).

In a third example of creating a new document depicted in FIG. 3E, John intends to mask the range of cells (A3:A6) in the new document from the view of Jane. John first activates the concealment function by clicking a ‘conceal’ icon (not shown). John then selects masked cells 302E by right clicking a mouse on cell A3, dragging down to cell A6, and releasing the mouse button. John completes the concealment activity by clicking the ‘conceal’ icon (not shown) another time to select the content for concealment. As shown in FIG. 3E, the four cells in the range (A3:A6) are outlined. When Jane requests to see the spreadsheet, the result of the concealment is shown in FIG. 3F. After concealment, the content within cells in the range (A3:A6) are hidden from the view of Jane as indicated by masked cells 302F. Jane is aware that there are additional four additional Supplier nations but Jane cannot see the names of the four nations.

In a fourth of updating an existing document example depicted in FIG. 3G, John intends to make “Row 2” and “Column F” in an existing spreadsheet invisible to Jane and to mask the range of cells (A2:A6) in the existing spreadsheet from the view of Jane. John first activates the concealment function by clicking a ‘conceal’ icon (not shown). Using selection techniques previously discussed, John then selects invisible row 302G, invisible column 304G and masked cells 306G. John completes the concealment activity by clicking the ‘conceal’ icon (not shown) another time to select the content for concealment. As shown in FIG. 3G, the “Row 2” identifier is shaded and the entire row is outlined, the “Column F” identifier is shaded and the entire column is outlined, and the range of cells (A2:A6) is outlined. When Jane requests to see the spreadsheet, the result of the concealment is shown in FIG. 3H. After concealment, the row of data for the U.S. is not visible to Jane and the remaining rows in the spreadsheet move up one row, the column of Final Profit data is not visible to Jane and is now blank, and the content in cells (A2:A5) is masked from the view of Jane, as indicated by masked cells 302H.

In a fifth example of creating a new document depicted in FIG. 3I, John intends to mask specific content in a new text document from Jane. John first activates the concealment function by clicking a ‘conceal’ icon (not shown). Using techniques previously discussed, John then selects the specific content within the text document. John completes the concealment activity by clicking the ‘conceal’ icon (not shown) another time to select the content for concealment. As shown in FIG. 3I, the specific content is highlighted. When Jane requests to see the spreadsheet, the result of the concealment is shown in FIG. 3J. After concealment, each specific content is masked from the view of Jane.

In a sixth example of requesting that an existing document be sent to Jane (not shown), John has made the second spreadsheet, in a workbook that includes three total spreadsheets, invisible to Jane. John first activated the concealment function by clicking a ‘conceal’ icon (not shown). John then selected the identifier (i.e., tab) for the second spreadsheet in the workbook. John completed the concealment activity by clicking the ‘conceal’ icon (not shown) another time to select the content for concealment. When Jane requests that the spreadsheet be sent to Jane, the result of the concealment is that Jane can only see two spreadsheets in the workbook and Jane is not aware that a third spreadsheet exists.

FIG. 4 depicts computer system 400, which is an example of a system that includes conceal program 134. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for concealing content in a shared document, the method comprising:
receiving, by one or more computer processors, from a first user, a first set of user concealment attributes, wherein the first set of user concealment attributes are associated with a document;
receiving, by one or more computer processors, from the first user, a first set of document concealment attributes, wherein the first set of document concealment attributes are associated with the document; and
storing, by one or more computer processors, the document based on the first set of user concealment attributes associated with the document and the first set of document concealment attributes associated with the document.

2. The method of claim 1, further comprising:
receiving, by one or more computer processors, an input from a second user, wherein the input includes a request to send the document to the second user;
reviewing, by one or more computer processors, the first set of document concealment attributes, associated with the document, and the first set of user concealment attributes associated with the document;
creating, by one or more computer processors, a second document, wherein the second document is a modified version of the document based on the first set of document concealment attributes associated with the document and the first set of user concealment attributes associated with the document; and
sending, by one or more computer processors, the second document to the second user.

3. The method of claim 1, further comprising:
receiving, by one or more computer processors, an input from a third user, wherein the input includes a request to update the document;
retrieving, by one or more computer processors, the document from a repository;
determining, by one or more computer processors, whether the third user is included in the first set of user concealment attributes associated with the document; and
responsive to determining that the third user is included in the first set of user concealment attributes associated with the document, updating, by one or more computer processors, the document with the requested update from the third user, wherein the requested update complies with the first set of user concealment attributes associated with the document and the first set of document concealment attributes associated with the document.

4. The method of claim 1, wherein a type of document for the document is selected from the group consisting of a text file, a spreadsheet file, a set of spreadsheet files, a presentation file, a database file, and a project management file.

5. The method of claim 1, wherein the first set of document concealment attributes is selected from the group consisting of masked content, invisible content, both masked content and invisible content, and a scope of any included concealment in the document.

6. The method of claim 5, wherein the scope of any included concealment attributes in the document is selected from the group consisting of a range of cells in a spreadsheet file, one or more rows in a spreadsheet file, one or more columns in a spreadsheet file, one or more sheets in a set spreadsheet files, one or more lines in a text file, one or more paragraphs in a text file, and one or more pages in a text file.

7. The method of claim 1, wherein the first set of user concealment attributes is selected from the group consisting of whether the user is an owner of the document, whether the user is a delegate of the owner of the document, and whether the user has an authorization to view portions of the document or view the entire document.

8. A computer program product for concealing content in a shared document, the computer program product comprising:
one or more computer readable storage media; and
program instructions, stored on the one or more computer readable storage media, the program instructions comprising:
program instructions to receive, from a first user, a first set of user concealment attributes, wherein the first set of user concealment attributes are associated with a document;
program instructions to receive, from the first user, a first set of document concealment attributes, wherein the first set of document concealment attributes are associated with the document; and
program instructions to store the document based on the first set of user concealment attributes associated with the document and the first set of document concealment attributes associated with the document.

9. The computer program product of claim 8, further comprising program instructions, stored on the one or more computer readable storage media, to:
receive an input from a second user, wherein the input includes a request to send the document to the second user;
review the first set of document concealment attributes, associated with the document, and the first set of user concealment attributes associated with the document;
create a second document, wherein the second document is a modified version of the document based on the first set of document concealment attributes associated with the document and the first set of user concealment attributes associated with the document; and
send the second document to the second user.

10. The computer program product of claim 8, further comprising program instructions, stored on the one or more computer readable storage media, to:
receive an input from a third user, wherein the input includes a request to update the document;
retrieve the document from a repository;
determine whether the third user is included in the first set of user concealment attributes associated with the document; and
responsive to determining that the third user is included in the first set of user concealment attributes associated with the document, update the document with the requested update from the third user, wherein the requested update complies with the first set of user concealment attributes associated with the document and the first set of document concealment attributes associated with the document.

11. The computer program product of claim 8, wherein a type of document for the document is selected from the group consisting of a text file, a spreadsheet file, a set of spreadsheet files, a presentation file, a database file, and a project management file.

12. The computer program product of claim 8, wherein the first set of document concealment attributes is selected from the group consisting of masked content, invisible content, both masked content and invisible content, and a scope of any included concealment in the document.

13. The computer program product of claim 12, wherein the scope of any included concealment attributes in the document is selected from the group consisting of a range of cells in a spreadsheet file, one or more rows in a spreadsheet file, one or more columns in a spreadsheet file, one or more sheets in a set spreadsheet files, one or more lines in a text file, one or more paragraphs in a text file, and one or more pages in a text file.

14. The computer program product of claim 8, wherein the first set of user concealment attributes is selected from the group consisting of whether the user is an owner of the document, whether the user is a delegate of the owner of the document, and whether the user has an authorization to view portions of the document or view the entire document.

15. A computer system for concealing content in a shared document, the computer system comprising:
one or more computer processors;
one or more computer readable storage media; and
program instructions stored on the one or more computer readable storage media for execution by at least one of the one or more computer processors, the program instructions comprising:
program instructions to receive, from a first user, a first set of user concealment attributes, wherein the first set of user concealment attributes are associated with a document;
program instructions to receive, from the first user, a first set of document concealment attributes, wherein the first set of document concealment attributes are associated with the document; and
program instructions to store the document based on the first set of user concealment attributes associated with the document and the first set of document concealment attributes associated with the document.

16. The computer system of claim 15, further comprising program instructions, stored on the one or more computer readable storage media for execution by at least one of the one or more computer processors, to:
receive an input from a second user, wherein the input includes a request to send the document to the second user;
review the first set of document concealment attributes, associated with the document, and the first set of user concealment attributes associated with the document;
create a second document, wherein the second document is a modified version of the document based on the first set of document concealment attributes associated with the document and the first set of user concealment attributes associated with the document; and
send the second document to the second user.

17. The computer system of claim 15, further comprising program instructions, stored on the one or more computer readable storage media for execution by at least one of the one or more computer processors, to:
receive an input from a third user, wherein the input includes a request to update the document;
retrieve the document from a repository;
determine whether the third user is included in the first set of user concealment attributes associated with the document; and
responsive to determining that the third user is included in the first set of user concealment attributes associated with the document, update the document with the requested update from the third user, wherein the requested update complies with the first set of user concealment attributes associated with the document and the first set of document concealment attributes associated with the document.

18. The computer system of claim 15, wherein a type of document for the document is selected from the group consisting of a text file, a spreadsheet file, a set of spreadsheet files, a presentation file, a database file, and a project management file.

19. The computer system of claim 15, wherein the first set of document concealment attributes is selected from the group consisting of masked content, invisible content, both masked content and invisible content, and a scope of any included concealment in the document.

20. The computer system of claim 19, wherein the scope of any included concealment attributes in the document is selected from the group consisting of a range of cells in a spreadsheet file, one or more rows in a spreadsheet file, one or more columns in a spreadsheet file, one or more sheets in a set spreadsheet files, one or more lines in a text file, one or more paragraphs in a text file, and one or more pages in a text file.
